(19) United States
(12) Patent Application Publication
(10) Pub. No.: US 2017/0146077 A1
(43) Pub. Date: May 25, 2017

(54) SELECTABLE ONE-WAY CLUTCH

(71) Applicant: TOYOTA JIDOSHA KABUSHIKI KAISHA, Toyota-shi (JP)

(72) Inventors: Mitsuaki TOMITA, Susono-shi (JP); Hiroyuki SHIOIRI, Yokohama-shi (JP); Hideaki KOMADA, Gotenba-shi (JP); Hiroyuki SHIBATA, Odawara-shi (JP)

(73) Assignee: TOYOTA JIDOSHA KABUSHIKI KAISHA, Toyota-shi (JP)

(21) Appl. No.: 15/334,618

(22) Filed: Oct. 26, 2016

(30) Foreign Application Priority Data
Nov. 20, 2015 (JP) 2015-228129

(51) Int. Cl. F16D 41/12; F16D 41/02

(52) U.S. Cl. CPC F16D 41/125; F16D 41/02

(57) ABSTRACT

A selectable one-way clutch includes a pocket plate; a notch plate; engagement pieces housed in housing recesses of the pocket plate; elastic members biasing the engagement pieces; a selector plate switching states of the engagement pieces; and elastic bodies disposed at least in one of contact portions where contact are made between the engagement pieces and the notch plate and contact portions where contacts are made between the engagement pieces and the pocket plate.

### CROSS-REFERENCE TO RELATED APPLICATION(S)

The present application claims priority to and incorporates by reference the entire contents of Japanese Patent Application No. 2015-228129 filed in Japan on Nov. 20, 2015.

### BACKGROUND OF THE INVENTION

1. Field of the Invention

The present disclosure relates to a selectable one-way clutch.

2. Description of the Related Art

As a one-way clutch, for example, Japanese Patent Application Laid-open No. 2008-082478 discloses a selectable one-way clutch including a pocket plate in which a strut (an engagement piece) is housed in a plurality of pockets (housing recesses), a notch plate formed with a plurality of notches (engagement recesses), and a selector plate arranged between the pocket plate and the notch plate.

In such a selectable one-way clutch, a plurality of window holes are formed in a plate thickness direction of the selector plate. The selectable one-way clutch switches between, by rotating the selector plate, a state in which struts are raised through the window holes and engaged with notches and a state in which struts are confined in pockets in portions other than the window holes of a selector plate so as to release the engagement between the struts and the notches.

In a hybrid vehicle (HV vehicle) having the selectable one-way clutch described above incorporated therein, for example, when Electric Vehicle (EV) running is performed, as illustrated in FIG. 6 and FIG. 7, the vehicle is in a state in which a notch plate 12 rotates in a direction opposite to an engagement direction of a selectable one-way clutch (SOWC) 101 along with rotation of an output shaft system, that is, the vehicle is in an overrun state.

FIG. 8 illustrates an example of an alignment chart during EV running. As illustrated in FIG. 8, the rotation speed of an engine (ENG) becomes zero during the EV running, a first rotating electrical machine (MG1) outputs negative torque, and a second rotating electrical machine (MG2) outputs positive torque. In FIG. 8, as indicated by reference character N, the notch plate 12 rotates in the opposite direction (in a negative direction) to the engagement direction of the selectable one-way clutch 101.

In the overrun state, for example, when a selector plate 13 rotates and struts 113 are raised as illustrated in FIG. 6 and FIG. 7, as indicated by A to D in FIG. 6 and FIG. 7, there is a possibility that the struts 113 alternately collide with the notch plate 12 and a pocket plate 11 (the bottom part of the pocket 112) along with the rotation of the notch plate 12, and which results in short lifetime in service of the components such as the struts 113 and the like.

### SUMMARY OF THE INVENTION

It is an object of the present disclosure to at least partially solve the problems in the conventional technology.

A selectable one-way clutch includes: a pocket plate having one surface where a plurality of housing recesses are formed; a notch plate having one surface, which faces the one surface of the pocket place, where a plurality of engagement recesses are formed, and configured to rotate relative to the pocket plate; a plurality of engagement pieces having a plate-lake shape and being housed in the respective housing recesses; a plurality of elastic members disposed between bottom parts of the housing recesses and the respective engagement pieces and configured to bias the engagement pieces toward the respective engagement recesses; and a selector plate disposed between the pocket plate and the notch plate and configured to coaxially rotate with a rotation of the pocket plate to switch between a state where the engagement pieces are raised toward the engagement recesses and a state where the engagement pieces are housed in the housing recesses. Further, the selectable one-way clutch is in an engagement state, where the engagement pieces are engaged with the engagement recesses, in a case where the engagement pieces are raised toward the engagement recesses and the notch plate rotates in an engagement direction with respect to the pocket plate and is in a non-engagement state, where the engagement pieces are not engaged with the engagement recesses, in a case where the engagement pieces are housed in the engagement recesses or the notch plate rotates in a non-engagement direction, which is opposite to the engagement direction, with respect to the pocket plate. Further, the selectable one-way clutch further includes elastic bodies, which are disposed at least in one of first contact portions where contact are made between the engagement pieces and the notch plate and second contact portions where contacts are made between the engagement pieces and the pocket plate, the first contact portions and the second contact portions are contact portions where contacts are made when the engagement pieces are raised toward the engagement recesses and the notch plate rotates in the non-engagement direction with respect to the pocket plate.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is an exploded perspective view schematically illustrating an overall configuration of a selectable one-way clutch according to an embodiment of the present disclosure;

FIG. 2 is a cross-sectional view schematically illustrating a configuration of a selectable one-way clutch according to a first embodiment of the present disclosure;

FIG. 3 is a cross-sectional view schematically illustrating a configuration of a selectable one-way clutch according to a second embodiment of the present disclosure;

FIG. 4 is a cross-sectional view schematically illustrating a configuration of a selectable one-way clutch according to a third embodiment of the present disclosure;

FIG. 5 is a cross-sectional view schematically illustrating a configuration of a selectable one-way clutch according to a fourth embodiment of the present disclosure;

FIG. 6 is a cross-sectional view schematically illustrating a configuration of a selectable one-way clutch according to a conventional technique;

FIG. 7 is a cross-sectional view schematically illustrating a configuration of the selectable one-way clutch according to the conventional technique; and

FIG. 8 is an alignment chart during EV running.

### DETAILED DESCRIPTION OF THE PREFERRED EMBODIMENTS

Exemplary embodiments of a selectable one-way clutch (hereinafter may be referred to as “SOWC”) according the present disclosure will be described with reference to the accompanying drawings. The present disclosure is not limited to the following embodiments. Constituent elements in the following embodiments include elements that can be replaced by persons skilled in the art or that are substantially equivalent.

### First Embodiment

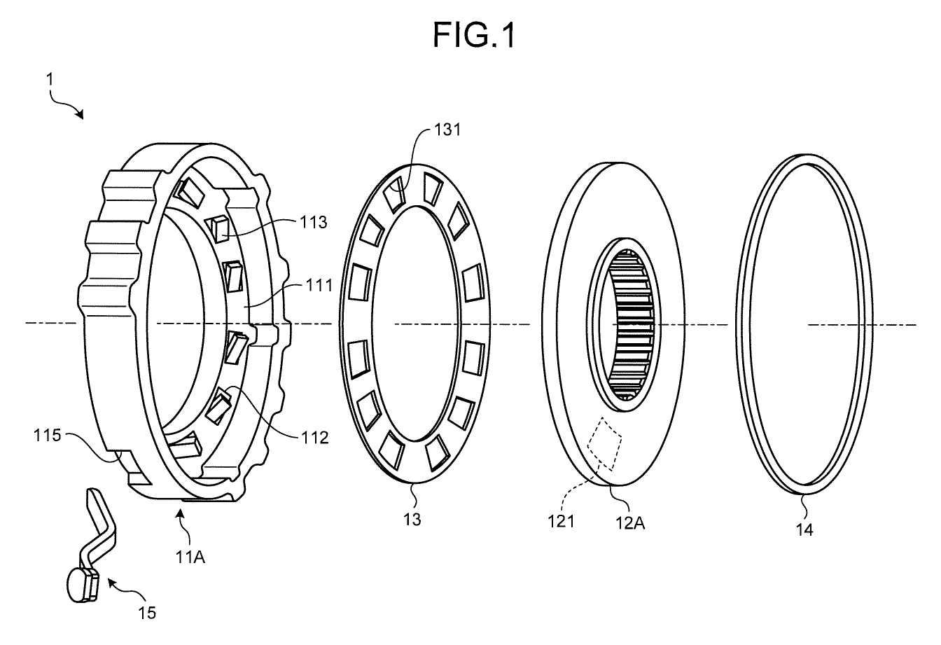

An SOWC 1 is incorporated in a power transmission device in, for example, a hybrid vehicle, and is switches between an engagement state (a lock state) and a non-engagement state (an unlock state) by rotating a switching member (a selector plate described below) arranged between a fixed side lace (a pocket plate described below) and a rotation side lace (a notch plate described below). As illustrated in FIG. 1, the SOWC 1 includes a pocket plate 11A, a notch plate 12A, a selector plate 13, a snap ring 14, and an arm 15.

As illustrated in FIG. 1, the pocket plate 11A is formed in a cylindrical shape, and an annular (hollow disc-shaped) flange 111 protruding on an inner circumference side is formed at one end of the pocket plate 11A in a direction of axis of a cylinder. The selector plate 13 and the notch plate 12A are sequentially arranged in the flange 111, and the snap ring 14 is lastly attached thereto, thereby assembling the pocket plate 11A, the selector plate 13, and the notch plate 12A integrally. Lubricant is supplied into the SOWC 1, that is, in between the pocket plate 11A, the selector plate 13, and the notch plate 12A. The “axis” described above refers to a rotation axis of the SOWC 1 and indicated in a dot-and-dash line in FIG. 1.

As illustrated in FIG. 1, a cutout 115 is formed on an outer circumference of the pocket plate 11A. The arm 15 is inserted into the cutout 115 to couple the arm 15 with the selector plate 13. As illustrated in FIG. 1, a plurality of pockets (housing recesses) 112 dented in the direction of axis (a plate thickness direction) are formed on one of the surfaces of the pocket plate 11A, that is, on a surface of the flange 111 facing the selector plate 13, and a plate-like strut (an engagement piece) 113 is housed in each of the pockets 112.

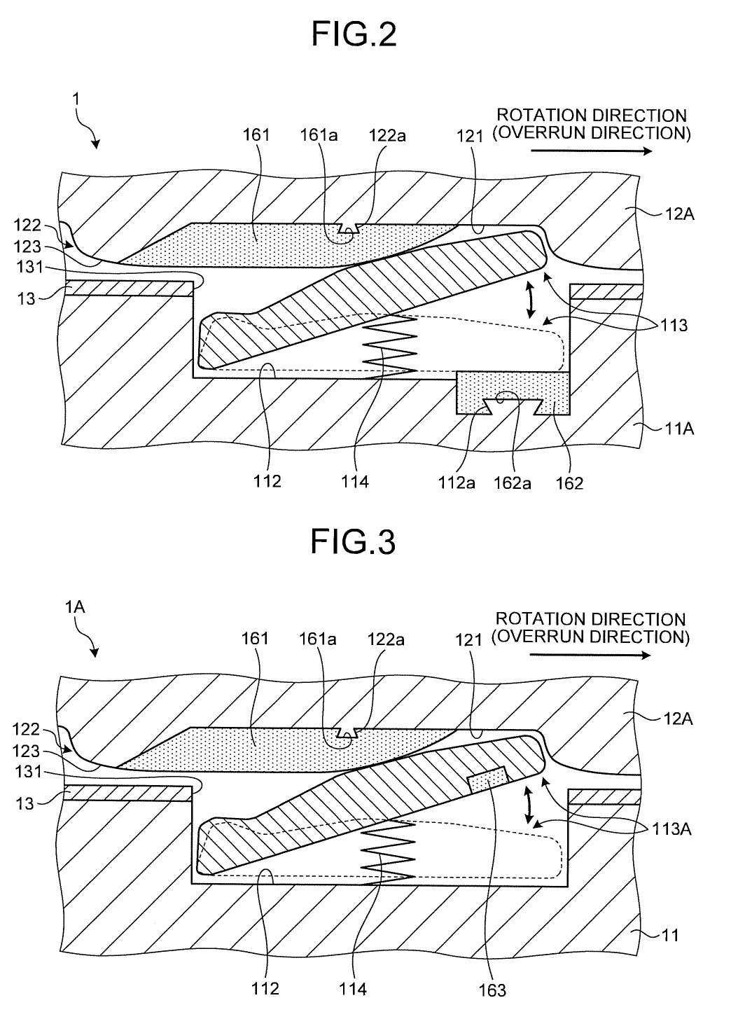

The pockets 112 are formed in the same number as that of notches 121 at positions corresponding to each of the notches 121 in the notch plate 12A on the surface of the flange 111. An elastic member 114 that biases the strut 113 toward the side of the notch plate 12A is arranged between the bottom of the pocket 112 and the strut 113 (see FIG. 2 described below).

The strut 113 is arranged (disposed) in the respective pockets 112. The strut 113 switches between a state in which one end of the strut 113 is raised toward the side of the notch 121 (the state of the strut 113 illustrated by a solid line in FIG. 2) and a state in which the entire strut 113 including the one end is housed in the pocket 112 (the state of the strut 113 illustrated by a dot-and-dash line in FIG. 2), by coaxially rotating the selector plate 13 with a rotation of the pocket plate 11A.

As illustrated in FIG. 1, the notch plate 12A is formed in an annular shape (a hollow disc shape) having an external diameter same as that of the flange 111 of the pocket plate 11A. The notch plate 12A is arranged to face the surface of the pocket plate 11A on which the pockets 112 are formed, and is able to rotate around the axis relative to the pocket plate 11A.

As illustrated in FIG. 1, a plurality of notches (engagement recesses) 121 dented in the direction of axis (the plate thickness direction) are formed on the surface facing the pocket plate 11A (pockets 112) of the surfaces of the notch plate 12A. The notches 121 are recesses into which one end of the strut 113 raised toward the side of the notch 121 is inserted respectively through each of window holes 131 in the selector plate 13. In FIG. 1, only one notch 121 is illustrated by a broken line. However, in practice, the notches 121 are formed in the same number as that of the pockets 112 and the struts 113 at the positions corresponding to the pockets 112 and the struts 113.

As illustrated in FIG. 1, the selector plate 13 is formed in an annular shape (a hollow disc shape) having the same external diameter and the inner diameter as those of the flange 111 of the pocket plate 11A. The selector plate 13 is arranged to face the pocket plate 11A and the notch plate 12A respectively. The selector plate 13 coaxially rotates with the rotation of the pocket plate 11A by a predetermined angle around the axis to switch an engagement state and a non-engagement state as described below.

The window holes 131 are formed in the selector plate 13, passing therethrough in the direction of axis (in the plate thickness direction) at positions corresponding to the pockets 112 and the struts 113 in the pocket plate 11A. As illustrated in FIG. 1, the window holes 131 are formed in the same number as that of the pockets 112 and the struts 113 at the position corresponding thereto.

When the position of the window hole 131 matches the position of the pocket 112 in a circumferential direction of the SOWC 1 (see FIG. 2 described below), one end of the strut 113 is pushed by the elastic member 114, and raised toward the side of the notch plate 12A (notches 121) through the window hole 131. When the notch plate 12A rotates in an engagement direction with respect to the pocket plate 11A in the state with the one end of the strut 113 being raised toward the side of the notch 121, the strut 113 engages with the notch 121, and the SOWC 1 becomes an engagement state.

In the engagement state, torque is transmitted between the pocket plate 11A and the notch plate 12A by the engagement between the strut 113 and the notch 121. The “engagement direction” described above refers to a rotation direction in a positive direction (also referred to as “ratchet direction”) in which the one end of the strut 113 engages with the notch 121, among the rotation directions of the notch plate 12A, and is a direction opposite to the rotation direction illustrated in FIG. 2.

On the other hand, in the circumferential direction of the SOWC 1, when the position of the window hole 131 is deviated from the position of the pocket 112, the pocket 112 is closed by a portion of the selector plate 13 where the window hole 131 is not formed, and the strut 113 is pushed to the side of the pocket 112 by the portion where the window hole 131 is not formed, and the entire strut 113 is housed in the pocket 112. Accordingly, the SOWC 1 becomes in a non-engagement state.

Furthermore, in the SOWC 1, when the notch plate 12A is rotating in the non-engagement direction opposite to the engagement direction with respect to the pocket plate 11A, the SOWC 1 becomes the non-engagement state irrespective of whether the one end of the strut 113 is in the raised state or the entire strut 113 is in the state housed in the pocket 112.

In the non-engagement state, because the strut 113 does not engage with the notch 121 (the engagement between the strut 113 and the notch 121 is released), torque is not transmitted between the pocket plate 11A and the notch plate 12A. The “non-engagement direction” described above refers to a rotation direction in a negative direction (hereinafter, may be referred to as a “overrun direction”) in which the one end of the strut 113 does not engage with the notch 121, among the rotation directions of the notch plate 12A, and is the rotation direction illustrated in FIG. 2.

The snap ring 14 is used to assemble the pocket plate 11A, the selector plate 13, and the notch plate 12A integrally as described above, and as illustrated in FIG. 1, the snap ring 14 is formed in an annular shape (a hollow disk shape) having the same external diameter as that of the flange 111 of the pocket plate 11A.

The arm 15 is used to transmit the drive force of an actuator (not illustrated) provided externally. As illustrated in FIG. 1, the arm 15 is inserted into the cutout 115 of the pocket plate 11A, and is coupled with the selector plate 13 inside the pocket plate 11A. An apical end of the arm 15 exposed from the cutout 115 is coupled with the actuator (not illustrated). By driving the actuator, the arm 15 moves to rotate the selector plate 13.

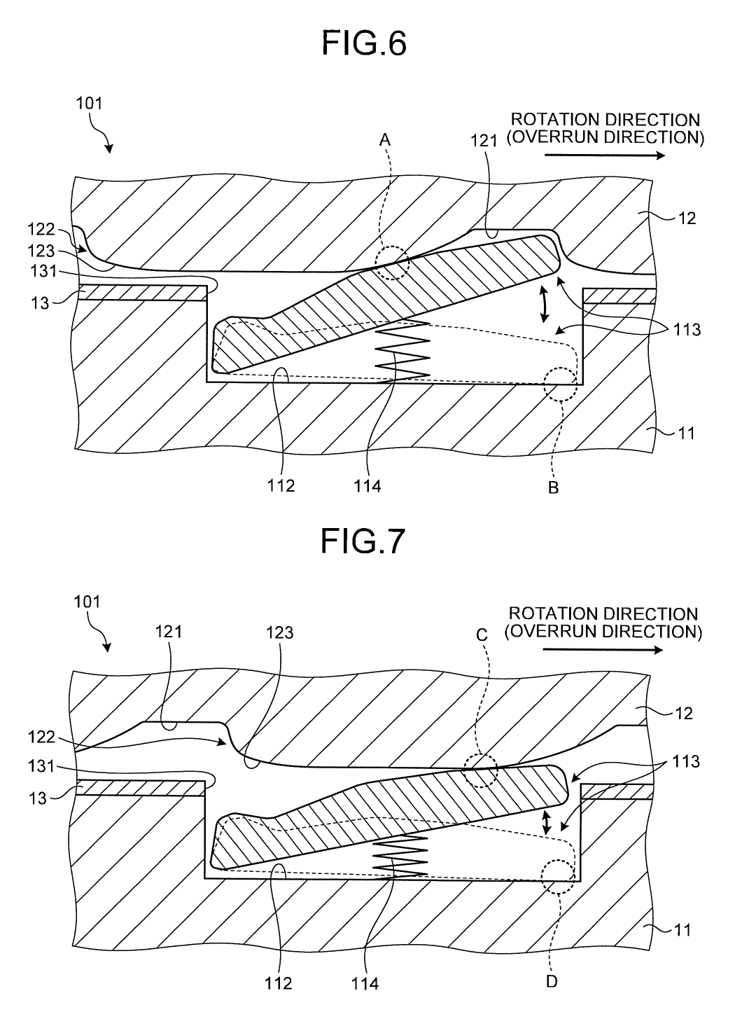

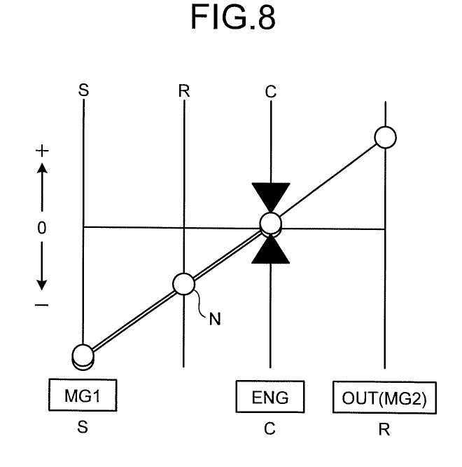

In a conventional hybrid vehicle provided with an SOWC 101, in the overrun state as illustrated in FIG. 6 and FIG. 7, when the selector plate 13 rotates to raise the struts 113, there is a possibility that the struts 113 collide with the notch plate 12 and the pocket plate 11 (the bottom of the pockets 112) alternately so as to cause short lifetime in service, wear, and the like of components such as the struts 113 and the elastic member 114. As a state in which the selector plate 13 rotates to raise the struts 113, such a case that the selector plate 13 is accidentally rotated due to a malfunction of the actuator (not illustrated) is included in addition to a case where the selector plate 13 is intentionally rotated by the actuator (not illustrated).

A general SOWC has a ratchet function so that when the notch plate 12 rotates at a high rotation speed above a certain level in the positive direction (the ratchet direction), the strut 113 is flipped by the notch plate 12 and does not engage therewith, in order to absorb impact torque at the time of engagement. In order to ensure strength satisfying the ratchet function, the pocket plate 11, the notch plate 12, and the struts 113 are made of cast iron.

Meanwhile, because the pocket plate 11, the notch plate 12, and the struts 113 are made of a material having high strength, even in the overrun state in which the notch plate 12 rotates in the negative direction (see FIG. 6 and FIG. 7), a reflection coefficient when the struts 113 are flipped by the notch plate 12 increases, thereby increasing the impact force at the time of collision. Therefore, there is a possibility that short lifetime in service of components described above occurs.

In order to prevent short lifetime in service of components in the overrun state, for example, a method for reducing the number of collisions by reducing the number of notches 121 can be considered. However, if the number of notches 121 is decreased, backlash increases to increase the impact torque at the time of engagement. When durability of T/A (transaxle) built-in components is taken into consideration, this method is not preferable.

Therefore, as illustrated in FIG. 2, the SOWC 1 according to the present embodiment is provided with an elastic body at least in one of a contact portion between the strut 113 and the notch plate 12A and a contact portion between the strut 113 and the pocket plate 11A, which is a contact portion that the strut 113 comes into contact therewith when the strut 113 is raised toward the side of the notch 121 by the selector plate 13 and the notch plate 12A is rotating in the non-engagement direction (the overrun direction) with respect to the pocket plate 11A.

In the SOWC 1, specifically as illustrated in FIG. 2, an elastic body 161 made of an elastic material such as rubber is provided on the side of the notch plate 12A in the contact portion between the strut 113 and the notch plate 12A. The elastic body 161 is provided by cutting a part of a portion of the notch plate 12A other than the notches 121 (hereinafter, a “notch unformed portion 122”) and provided in the cut portion. The elastic body 161 is provided in the cut portion so as to hold the original profile (shape, outline) of the notch plate 12A. That is, the notch plate 12A provided with the elastic body 161 and the notch plate 12 not provided with the elastic body 161 (see FIG. 6) have the same profile. Therefore, the engagement operation or the non-engagement operation of the SOWC 1 is not interrupted due to the presence of the elastic body 161.

As a method for providing the elastic body 161 in the notch plate 12A, for example as illustrated in FIG. 2, such a method can be mentioned that a locking part 122a is formed on the side of the notch plate 12A and a part to be locked 161a is formed on the side of the elastic body 161, and by locking the locking part 122a to the part to be locked 161a to fix the both parts. However, the notch plate 12A and the elastic body 161 can be directly bonded to each other by, for example, bonding, welding, or the like without forming the locking part 122a and the part to be locked 161a.

A ratchet functional part 123 for realizing the ratchet function described above is provided in the notch unformed portion 122 of the notch plate 12A. The ratchet functional part 123 is used to flip the strut 113 when the notch plate 12A rotates in the positive direction (the ratchet direction) at a high rotation speed above a certain level and means a gradually curved portion in the notch unformed portion 122. The elastic body 161 is provided in a portion other than the ratchet functional part 123 in the notch unformed portion 122, so as not to hinder the ratchet function.

The SOWC 1 is also provided with an elastic body 162 made of rubber or the like on the side of the pocket plate 11A, as illustrated in FIG. 2, in the contact portion between the strut 113 and the pocket plate 11A. The elastic body 162 is provided by cutting a part of the bottom surface of the pocket 112 and provided in the cut portion. It is preferable to provide the elastic body 162 at a height at least higher than the bottom surface of the pocket 112, and for example as illustrated in FIG. 2, the elastic body 162 is provided so that an upper part thereof slightly protrudes from the cut portion.

As a method for providing the elastic body 162 in the pocket plate 11A, for example as illustrated in FIG. 2, such a method can be mentioned that a locking part 112a is formed on the side of the pocket plate 11A and a part to be locked 162a is formed on the side of the elastic body 162, and by locking the locking part 112a to the part to be locked 162a to fix the both parts. However, the pocket plate 11A and the elastic body 162 can be directly bonded to each other by, for example, bonding, welding, or the like without forming the locking part 112a and the part to be locked 162a.

The SOWC 1 having the configuration described above is provided with the elastic bodies 161 and 162 respectively in the contact portion between the strut 113 and the notch plate 12A and the contact portion between the strut 113 and the pocket plate 11A. Therefore, short lifetime in service of components such as the struts 113 can be prevented, even if the struts 113 collide with the notch plate 12A and the pocket plate 11A alternately in the overrun state.

### Second Embodiment

An SOWC 1A according to a second embodiment of the present disclosure is described below. The SOWC 1A has the same configuration as that of the SOWC 1 except for the position where an elastic body is provided. The pocket plate 11 in the SOWC 1A is the same as that of the SOWC 101 (see FIG. 6).

As illustrated in FIG. 3, the SOWC 1A is provided with an elastic body 161 made of rubber or the like on the side of the notch plate 12A in the contact portion between strut 113A and the notch plate 12A. The configuration of the elastic body 161 is the same as that of the first embodiment (see FIG. 2).

The SOWC 1A is also provided with an elastic body 163 made of rubber or the like on the side of the strut 113A in the contact portion between the strut 113A and the pocket plate 11. The elastic body 163 is provided by cutting a part of the strut 113A on the side of the pocket 112 and provided in the cut portion. The elastic body 163 is provided in the cut portion so as to hold an original profile (shape, outline) of the strut 113A. That is, the strut 113A provided with the elastic body 163 and the strut 113 not provided with the elastic body 163 (see FIG. 6) have the same profile. Therefore, the engagement operation or the non-engagement operation of the SOWC 1A is not interrupted due to the presence of the elastic body 163.

For the sake of convenience of description, the bottom surface of the pocket 112 is expressed by a flat surface in FIG. 3. However, in practice, the pocket 112 is provided with irregularities on the bottom surface thereof. The strut 113A is configured such that when the strut 113A collides with the bottom surface of the pocket 112, the portion provided with the elastic body 163 collides with the bottom surface (convex portions formed thereon) of the pocket 112.

The SOWC 1A having the configuration described above is provided with the elastic bodies 161 and 163 respectively in the contact portion between the strut 113A and the notch plate 12A and the contact portion between the strut 113A and the pocket plate 11. Therefore, short lifetime in service of components such as the struts 113A can be prevented, even if the struts 113A collide with the notch plate 12A and the pocket plate 11 alternately in the overrun state.

### Third Embodiment

An SOWC 1B according to a third embodiment of the present disclosure is described below. The SOWC 1B has the same configuration as that of the SOWC 1 except for the position where the elastic body is provided. The notch plate 12 in the SOWC 1B is the same as that of the SOWC 101 (see FIG. 6).

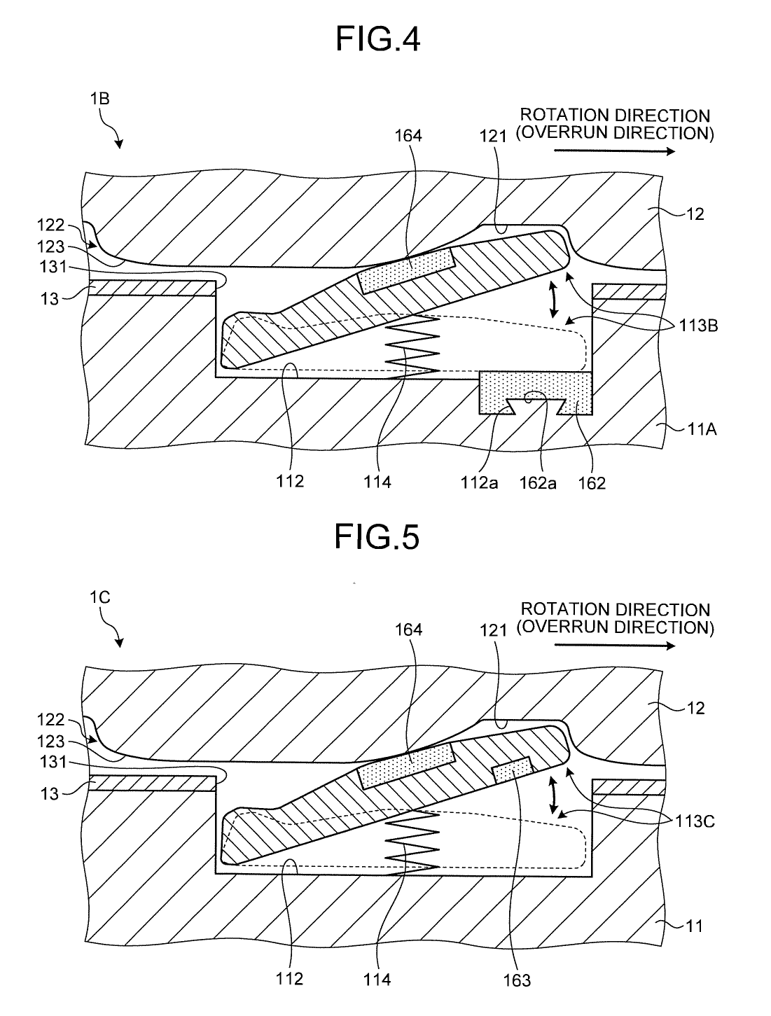

As illustrated in FIG. 4, the SOWC 1B is provided with an elastic body 164 on the side of a strut 113B in the contact portion between the strut 113B and the notch plate 12. The elastic body 164 is provided by cutting a part of the strut 113B on the side of the notch plate 12 and provided in the cut portion. The elastic body 164 is provided on the cut portion side so as to hold an original profile (shape, outline) of the strut 113B. That is, the strut 113B provided with the elastic body 164 and the strut 113 not provided with the elastic body 164 (see FIG. 6) have the same profile. Therefore, the engagement operation or the non-engagement operation of the SOWC 1B is not interrupted due to the presence of the elastic body 164.

The SOWC 1B is also provided with an elastic body 162 on the side of the pocket plate 11A in the contact portion between the strut 113B and the pocket plate 11A. The configuration of the elastic body 162 is the same as that of the first embodiment (see FIG. 2).

The SOWC 1B having the configuration described above is provided with the elastic bodies 164 and 162 respectively in the contact portion between the strut 113B and the notch plate 12 and the contact portion between the strut 113B and the pocket plate 11A. Therefore, short lifetime in service of components such as the struts 113B can be prevented, even if the struts 113B collide with the notch plate 12 and the pocket plate 11A alternately in the overrun state.

### Fourth Embodiment

An SOWC 1C according to a fourth embodiment of the present disclosure is described below. The SOWC 1C has the same configuration as that of the SOWC 1 except for the position where the elastic body is provided.

As illustrated in FIG. 5, the SOWC 1C is provided with an elastic body 164 on the side of a strut 113C in the contact portion between the strut 113C and the notch plate 12. The configuration of the elastic body 164 is the same as that of the third embodiment described above (see FIG. 4).

The SOWC 1C is also provided with an elastic body 163 on the side of the strut 113C in the contact portion between the strut 113C and the pocket plate 11. The configuration of the elastic body 163 is the same as that of the second embodiment described above (see FIG. 3).

The SOWC 1C having the configuration described above is provided with the elastic bodies 164 and 163 respectively in the contact portion between the strut 113C and the notch plate 12 and the contact portion between the strut 113C and the pocket plate 11. Therefore, short lifetime in service of components such as the struts 113C can be prevented, even if the struts 113C collide with the notch plate 12 and the pocket plate 11 alternately in the overrun state.

The selectable one-way clutch according to the present disclosure has been specifically described above in the modes for carrying out the present disclosure. However, the spirit of the present disclosure is not limited to the descriptions of the embodiments and should be interpreted widely based on the descriptions of the claims. Further, needless to mention that various modifications and changes based on the descriptions are included in the spirit of the present disclosure.

For example, in the SOWC 1 described above (see FIG. 2), the elastic body 161 is provided on the side of the notch plate 12A in the contact portion between the strut 113 and the notch plate 12A, and the elastic body 162 is provided on the side of the pocket plate 11A in the contact portion between the strut 113 and the pocket plate 11A. However, only the elastic body 161 is provided on the side of the notch plate 12A without providing the elastic body 162 on the side of the pocket plate 11A.

Furthermore, in the SOWC 1 (see FIG. 2) described above, the elastic body 161 is provided on the side of the notch plate 12A in the contact portion between the strut 113 and the notch plate 12A, and the elastic body 162 is provided on the side of the pocket plate 11A in the contact portion between the strut 113 and the pocket plate 11A. However, only the elastic body 162 is provided on the side of the pocket plate 11A without providing the elastic body 161 on the side of the notch plate 12A.

In the SOWC 1A (see FIG. 3) described above, the elastic body 161 is provided on the side of the notch plate 12A in the contact portion between the strut 113A and the notch plate 12A, and the elastic body 163 is provided on the side of the strut 113A in the contact portion between the strut 113A and the pocket plate 11. However, only the elastic body 163 is provided on the side of the strut 113A without providing the elastic body 161 on the side of the notch plate 12A.

Furthermore, in the SOWC 1B (see FIG. 4) described above, the elastic body 164 is provided on the side of the strut 113B in the contact portion between the strut 113B and the notch plate 12, and the elastic body 162 is provided on the side of the pocket plate 11A in the contact portion between the strut 113B and the pocket plate 11A. However, only the elastic body 164 is provided on the side of the strut 113B without providing the elastic body 162 on the side of the pocket plate 11A.

According to an embodiment of the present disclosure, because the selectable one-way clutch is provided with an elastic body at least in one of a contact portion between an engagement piece and a notch plate and a contact portion between an engagement piece and a pocket plate, impact force at the time of collision can be absorbed by the elastic body, thereby enabling to prevent short life in service of components such as struts.

According to an embodiment of the present disclosure, the selectable one-way clutch according to the present disclosure is provided with an elastic body on the side of the notch plate, in the contact portion between the engagement piece and the notch plate that come into contact with each other when the engagement piece is in the raised state toward the side of the engagement recess and the notch plate is rotating in the non-engagement direction with respect to the pocket plate.

According to an embodiment of the present disclosure, because the selectable one-way clutch is provided with the elastic body in the contact portion between the engagement piece and the notch plate, impact force at the time of collision can be absorbed by the elastic body, thereby enabling to prevent short life in service of components such as the struts.

According to an embodiment of the present disclosure, because the selectable one-way clutch is provided with the elastic body in the contact portion between the engagement piece and the notch plate, impact force at the time of collision can be absorbed by the elastic body, thereby enabling to prevent short life in service of components such as the struts.

According to an embodiment of the present disclosure, because the selectable one-way clutch is provided with the elastic body in the contact portion between the engagement piece and the pocket plate, impact force at the time of collision can be absorbed by the elastic body, thereby enabling to prevent short life in service of components such as the struts.

According to an embodiment of the present disclosure, because the selectable one-way clutch is provided with the elastic body in the contact portion between the engagement piece and the pocket plate, impact force at the time of collision can be absorbed by the elastic body, thereby enabling to prevent short life in service of components such as the struts.

According to an embodiment of the present disclosure, short life in service of components can be prevented even if an engagement piece collides with a notch plate and a pocket plate alternately in an overrun state.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A selectable one-way clutch comprising:
a pocket plate having one surface where a plurality of housing recesses are formed;
a notch plate having one surface, which faces the one surface of the pocket place, where a plurality of engagement recesses are formed, and configured to rotate relative to the pocket plate and;
a plurality of engagement pieces having a plate-lake shape and being housed in the respective housing recesses;
a plurality of elastic members disposed between bottom parts of the housing recesses and the respective engagement pieces and configured to bias the engagement pieces toward the respective engagement recesses; and
a selector plate disposed between the pocket plate and the notch plate and configured to coaxially rotate with a rotation of the pocket plate to switch between a state where the engagement pieces are raised toward a side of the engagement recesses and a state where the engagement pieces are housed in the housing recesses, wherein
the selectable one-way clutch is in an engagement state, where the engagement pieces are engaged with the engagement recesses, in a case where the engagement pieces are raised toward the side of the engagement recesses and the notch plate rotates in an engagement direction with respect to the pocket plate and is in a non-engagement state, where the engagement pieces are not engaged with the engagement recesses, in a case where the engagement pieces are housed in the engagement recesses or the notch plate rotates in a non-engagement direction, which is opposite to the engagement direction, with respect to the pocket plate, and wherein
the selectable one-way clutch further comprises elastic bodies, which are disposed at least in one of first contact portions, where contact are made between the engagement pieces and the notch plate, and second contact portions, where contacts are made between the engagement pieces and the pocket plate, the first contact portions and the second contact portions being contact portions where contacts are made when the engagement pieces are raised toward the side of the engagement recesses and the notch plate rotates in the non-engagement direction with respect to the pocket plate.

2. The selectable one-way clutch according to claim 1, wherein the elastic bodies are disposed on a side of the notch plate of the first contact portions.

3. The selectable one-way clutch according to claim 1, wherein the elastic bodies are disposed on a side of the engagement pieces of the first contact portions.

4. The selectable one-way clutch according to claim 1, wherein the elastic bodies are disposed on a side of the pocket plate of the second contact portions.

5. The selectable one-way clutch according to claim 2, wherein the elastic bodies are further disposed on a side of the pocket plate of the second contact portions.

6. The selectable one-way clutch according to claim 3, wherein the elastic bodies are further disposed on a side of the pocket plate of the second contact portions.

7. The selectable one-way clutch according to claim 1, wherein the elastic bodies are disposed on a side of the engagement pieces of the second contact portions.

8. The selectable one-way clutch according to claim 2, wherein the elastic bodies are disposed on a side of the engagement pieces of the second contact portions.

9. The selectable one-way clutch according to claim 3, wherein the elastic bodies are disposed on a side of the engagement pieces of the second contact portions.
